(19) United States
(12) Patent Application Publication
(10) Pub. No.: US 2003/0197878 A1
(43) Pub. Date: Oct. 23, 2003

(54) Data encoding and workpiece authentication using halftone information

(76) Inventors: Eric Metois, Arlington, MA (US); Joshua R. Smith, Cambridge, MA (US); Paul M. Yarin, Cambridge, MA (US)

Correspondence Address: CESARI AND MCKENNA, LLP, 88 BLACK FALCON AVENUE, BOSTON, MA, 02210, US

(21) Appl. No.: 10/254,171

(22) Filed: Sep. 25, 2002

Related U.S. Application Data
(60) Provisional application No. 60/373,213, filed on Apr. 17, 2002.

(51) Int. Cl. G06K 15/02; H04N 1/52

(52) U.S. Cl. 358/1.9; 358/536

(57) ABSTRACT

An encoding system includes data in an underlying image by controlling or modifying halftone settings, which are used in the associated printing color process to produce a hard-copy document or an on-screen image. The system encodes the data into the image by selectively varying, in accordance with the data, the order of various color channels, and/or the screen angles and/or spatial frequencies, or scales, of associated halftone screens. The system encodes an N-bit payload in the image by modifying the halftone settings of certain or all of the color channels in accordance with the data. The system thus uses the color channels also as “data channels.” The system prints the encoded image by incorporating the modified halftone settings into the respective halftone screens, and applying the inks in a conventional manner. To recover the data from the image, the system performs a Fourier transform of the halftone screen and determines the halftone screen angles and spatial frequencies associated with the various channels based on the angle and radius of associated energy peaks in the Fourier plane. Thereafter, the system associates data symbols with the halftone parameters. The encoding system may also authenticate the image by including therein a counterfeit check code that has a predetermined relationship with the data. The system then checks authenticity by determining if the decoded counterfeit check code has the same relationship with the decoded data. Alternatively, the system may encode halftone parameters or information that indicates the halftone parameters in a digital code that is encoded onto or proximate the image. The system then checks authenticity by determining if the settings used in the printing of the image correspond to the parameters decoded from the image and/or parameters associated with the decoded information.

### CROSS-REFERENCE TO RELATED APPLICATIONS

The present application claims the benefit of U.S. Provisional Patent Application Serial No. 60/373,213, which was filed on Apr. 17, 2002, by Eric Metois and Joshua R. Smith and Paul M. Yarin for a DATA ENCODING AND WORKPIECE AUTHENTICATION USING HALFTONING and is hereby incorporated by reference.

### BACKGROUND OF THE INVENTION

The invention relates generally to data encoding and decoding and, more particularly, to encoding data into and decoding data from an image. The invention further relates to authenticating an image using as authentication information a description of associated halftone characteristics.

### BACKGROUND INFORMATION

There are numerous applications in which machine readable data must be encoded on a paper document or other substrate. Typically such data is encoded using a printable symbology, either as a form of barcode, or as characters optimized for Optical Character Recognition, i.e., in an “OCR type font.” There are numerous applications of machine readable printed symbologies, for example: product identification—notably the ubiquitous Universal Product Code symbol, document identification, postal mailpiece identification and sorting, and so on. Even postage itself may be represented by a machine readable printed symbology, as for example in the United States Postal Service's Information Based Indicia Program.

A barcode specifies data symbols as an arrangement of lines that vary in relative size and spacing. In one dimensional (1-D) barcodes the lines vary by width and relative horizontal spacing. In two dimensional (2-D) barcodes, the lines vary also by relative vertical length or relative position. As is common, the barcodes may be overlaid on an otherwise blank portion of, for example, a price tag.

The three main advantages of barcodes are that they are printable using a simple “black and white” printing process, are machine readable using a scanner, and are easily decoded. However, current barcodes suffer from a number of limitations, Specifically, 1D barcodes do not encode enough data per square inch of paper for many applications. Two dimensional barcodes encode more data, but are visually obtrusive. Typically, a barcode must have its own reserved area including a white or uniform background for the barcode itself, as well as a white or uniform border (known as a “quiet zone”) that is actually larger than the barcode itself. We refer to the reserved area and the quiet zone together as the “barcode region.” Other visual content must be eliminated from the barcode region, which in most practical applications limits the realizable data carrying capacity since the space, or “real estate,” that may be devoted solely to the machine readable symbol is limited.

Barcodes may also be too visually intrusive to be combined with certain media, such as, for example, photographic images. A combination of the barcode region and the underlying image essentially obliterates the portions of the image in which the barcode is included. Accordingly, the use of the barcode may not be acceptable. Further, the relative spacings, widths and other characteristics of the barcode may be altered if the combined image is scaled or compressed for transmission, or if the combined image is tilted or rotated as it is scanned for transmission. In addition, the barcode may be defaced before, during or after transmission. The encoded data in the received image cannot then be accurately decoded by the recipient.

Further, another of the reasons that barcodes and other prior printed symbologies cannot be successfully combined with images is that they typically encode the data in a spatially localized form, which means that if any portion of the symbol is destroyed, not viewable by the scanner, or obfuscated by an image, a portion or all of the data may be lost. The localized representation of the data thus limits the robustness of the encoding.

A final limitation of most symbologies known in the art is their stringent registration requirements. The coded pattern must be correctly oriented, positioned and sized relative to a viewing window of the scanner in order to be properly read and decoded. If only a portion of the barcode passes by the viewing window or the code is incorrectly registered, the scanner may misinterpret the data included in the coded pattern, without notifying the user of the mistake. It is necessary for the reading device effectively to view and identify the edges (left and right for a 1D barcode, left, right, top, and bottom for a 2D barcode) of the bar code region before any of the data can be recovered. If the edges of the barcode region are obfuscated, out of view, or destroyed, the scanner may not be able to decode any of the data, even though only a small edge portion of the coded pattern and/or the surrounding quiet zone has been destroyed or is not viewable by the scanner. In addition, with the stringent registration requirements, barcodes and other prior printed symbologies are not particularly well suited for use in fully automated reading system.

In systems such as a market checkout, for example, a user is present to properly position and orient the coded pattern, for example, the barcode, relative to the viewing window. Thus, it is commonplace for a user to move an object further from or closer to the window, and/or reorient the product relative to the window until the check-out scanner correctly decodes the price, product type and so forth. In a fully automated system, however, registration of the barcodes relative to the scanner window may be a problem if the underlying media tilts, rotates or shifts relative to the scanned window. Accordingly, the barcodes may not be successfully read.

In a prior pending application that is assigned to a common assignee and incorporated herein in its entirety by reference, namely, U.S. patent application Ser. No. 09/921,172 entitled “Data Encoding and Decoding Using Angular Symbology,” a mechanism is described for encoding data onto an image using “angular symbology” that is independent of translation and rotation. The coded pattern, which resembles a texture, may be combined with the underlying image as an added graininess.

Briefly, the data are encoded by varying an image characteristic in accordance with modulation patterns, which have relative angular orientations and frequencies that correspond to the data. The modulation patterns may be, for example, sinusoidal linear patterns, and the image characteristic that is varied in accordance with the sinusoidal patterns may be, for example, pixel intensity.

To encode the data, which consists of a string of symbols, the system first selects a reference orientation and a reference frequency. The reference frequency is preferably selected to be the highest spatial frequency in a group or band of frequencies used to produce the coded pattern. The system next associates one or more symbols with each of the remaining spatial frequencies in the band by, for example, assigning a first set of symbols to the highest of the remaining set of frequencies, a second set of symbols to the next highest of the frequencies, and so forth. The system then assigns angular orientations to the respective symbols based on the numerical values of the symbols, where the “values” correspond to the underlying bits that are to be encoded in the components. Finally, the system determines how pixel intensities are to be varied by a combination of the reference and data components, in order to impress a corresponding coded pattern on the substrate. Typically, this is done by printing the pattern on the substrate. For example, the coded pattern may be combined with one or more non-coded images by adding a graininess to the underlying images.

The system decodes the data essentially by performing a 2-D fast Fourier transform (FFT) of the coded pattern, to recover spatial frequencies and angular orientations. The resultant transform defines a set of “reference points” and various sets of “data points,” each of which are characterized by a frequency and an angular orientation corresponding to that of the visual modulation patterns that were impressed on the document. The system determines the reference orientation by determining the points of maximum energy at the reference spatial frequency. These points, which are the reference points, define a reference axis from which the angular orientations of the respective sets of data points are determined. The system then decodes the angular information for the frequencies-of-interest into corresponding symbols, and arranges the symbols to reproduce the data.

The angular symbology produces a coded pattern that is both translation and rotation independent, since rotation and translation do not change the spatial frequency or the relative angular orientation information obtained using the FFT.

We discuss below an alternative encoding scheme that can be used alone or in conjunction with the angular symbology, to encode data onto an image. The alternative encoding scheme may also be used to authenticate a document, as further discussed below.

### SUMMARY OF THE INVENTION

The invention is an encoding system that includes data in an underlying image by controlling or modifying halftone settings, which are used in the associated printing color process to produce a hard-copy document or an on-screen image. The system encodes the data into the image by selectively varying, in accordance with the data, the order of various color channels and/or the angles and/or spatial frequencies, or scales, of associated halftone screens. The system may also authenticate the image based on the halftone characteristics.

Briefly, the halftone settings for color printing reproduce the colors of an original image using four color channels, namely, a cyan (C) channel, a magenta (M) channel, a yellow (Y) channel and a black (K) channel. For each channel, the printing color process uses a dedicated halftone screen to control how much of the associated ink is deposited at locations in the image. The four respective screens have particular orientations on the document and thus relative to one another, and the screens generally have the same spatial frequency or scale, i.e., lines-per-inch. The halftone settings dictate the selected scale and the various orientations of the halftone screens, such that the combination of the four inks produces the desired colors throughout the image.

The system encodes an N-bit payload in the image by modifying the halftone settings of certain or all of the color channels in accordance with the data. The system thus uses the color channels also as “data channels.” The system prints the encoded image by incorporating the modified halftone settings into the respective halftone screens, and applying the inks in a conventional manner.

Each halftone screen is essentially a square grid, and the Fourier transform of the halftone screen is also a square, which consists of four energy peaks. Each square on the plane has an angular orientation, modulo 90, that corresponds to the orientation of the associated halftone screen on the document, that is, to the “halftone screen angle.” The four points of the square are equally spaced from the center of the plane by a distance, or radius, that corresponds to the spatial frequency of the halftone screen. The system thus recovers the data by determining, from the Fourier plane, the angular orientations, i.e. screen angles, and the spatial frequencies associated with the various halftone screens and, thereafter, associating data symbols with the halftone parameters.

More specifically, the system encodes the data by first selecting the halftone settings for a reference channel to define a reference orientation and/or a reference spatial frequency. In the example, the system uses the K channel as the reference channel. The system then parses an N-bit payload into image symbols and assigns the image symbols to all or certain of the remaining channels. The system then modifies, in accordance with the symbols assigned to the respective channels, the relative screen angles and/or spatial frequencies for the associated halftone screens. Alternatively, or in addition, the relative order of the data-carrying channels is also varied in accordance with the assigned symbols. Finally, the system prints the encoded image using the reference and modified halftone settings for the associated halftone screens.

To retrieve data from the encoded image, the system performs a high-resolution scan of the image and performs a 2-D fast Fourier transform (FFT) of a portion of the image that contains unsaturated contributions from the C, M, Y and K channels. The Fourier representation contains energy peaks that correspond to the characteristics of the various C, M, Y and K halftone screens. The system analyses the results over the frequency domains of red (R), blue (B) and green (G) channels, which are compliments of the C, Y and M channels, respectively. The system essentially compares the energies associated with the various peaks across the R, B and G channels and assigns to the C, M and Y channels the peaks with the highest energy levels in the R, G and B channels, respectively. The system preferably uses for the K channel a reference spatial frequency that exceeds the spatial frequency or frequencies available for the remaining channels, and the system assigns to the K channel the energy peaks that correspond to the reference spatial frequency. The system also uses the reference spatial frequency to determine a scale factor for the image.

The system next determines the screen angles and, as appropriate, the spatial frequencies associated with the respective C, M and Y halftone screens, relative to the screen angle and the spatial frequency of the K channel. The system then associates the screen angles and/or the spatial frequencies and/or order of the channels with data symbols. Finally, the system reassembles the symbols in the appropriate order to reproduce the N-bit payload.

The system thus encodes the data into an image in a manner that is essentially visually imperceptible. Further, the encoding is independent of both translation and rotation, since rotation and translation do not change the spatial frequency or relative angular orientation information obtained using the FFT.

As discussed in more detail below, the encoding can also be used to determine if a printed image is authorized or a counterfeit. Briefly, a counterfeit check code is included in the N-bit payload for the purpose of authentication. The counterfeit check code may be, for example, a value that corresponds in a known manner to the data. If the print is authorized, the halftone settings decode to data and a counterfeit check code that correspond in the known manner. Otherwise, the halftone settings used for the counterfeit copy decode to essentially random bits that do not correspond to the data, and/or the counterfeit check code. The data in N-bit payload may instead be redundancy bits that correspond to the counterfeit check code, with the counterfeit check code set to a predetermined value.

Alternatively, the image may include a code or identifier that identifies the image and/or the image owner, and/or the coded identifier may be printed proximate the image. The identifier is associated with one or more sets of halftone setting parameters that may, for example, be held in a database. The system decodes the identifier and determines if the halftone parameters measured from the image correspond to the associated setting information contained in the database.

The data base may hold various sets of parameters for a particular image if, for example, the printing system and/or software have been altered or upgraded and produce images with different parameters using the same set of printer settings. The database may also include alternative sets of halftone setting information that are used, for example, by various other authorized printers. The system then verifies that an image is authorized by determining if the measured parameters correspond to any of the associated sets of values obtained from the database.

The system may also record the measured halftone parameters and the time of scanning of each image determined to be genuine, to have a record of the number and the associated measured halftone settings of each authorized copy of the image , as discussed in more detail below.

An alternative authentication method includes the halftone setting parameters in a digital code that is embedded in the image using, for example, a bar code, a watermark, or the angular symbology discussed above. The embedded digital code is later retrieved from a scanned version of a printed image, and the halftone parameters contained therein are compared to the halftone parameters measured from the scanned image. If the system determines that the recovered and measured halftone settings match, to within predetermined percentages, the system determines that the print is authorized. Otherwise, the system print is a counterfeit. Alternatively, the digital code used for authentication may be printed adjacent to the image, for example, in the image margin, as human or machine readable characteristics.

An advantage of embedding the digital code in the image using the angular symbology is that the halftone settings selected by the printing establishment need not be modified. Further, the visual impact of a bar code or other printed symbol in or near the image is avoided, as is the need for variable printing.

### BRIEF DESCRIPTION OF THE DRAWINGS

The invention description below refers to the accompanying drawings, of which:

FIGS. 1A and 1B depict a K channel and a corresponding Fourier plane.

FIG. 2 is a graph that depicts halftone screen angle and spatial frequency ranges;

FIG. 3 is a second graph that depicts halftone screen angle and spatial frequency ranges;

FIG. 4 is a graphical representation of reference and data points in the Fourier plane;

FIG. 5 is a functional block diagram of a halftone encoding system constructed in accordance with the invention;

FIG. 6 is a functional block diagram of a halftone decoding system constructed in accordance with the invention;

FIG. 7 is a functional block diagram of a halftone authentication system constructed in accordance with the invention;

FIG. 8 is a functional block diagram of a verification system constructed in accordance with the invention; and

FIG. 9 is a functional block diagram of a verification decoding system constructed in accordance with the invention.

### DETAILED DESCRIPTION OF AN ILLUSTRATIVE EMBODIMENT

Most printing systems have very limited dynamic range at the lowest level. At each point on the paper, a mark (e.g., ink) is either present or absent, and this corresponds to a single bit of dynamic range. In order to print a continuous tone image with wide dynamic range in each color channel, a halftoning process is used. This process creates the illusion of dynamic range at one spatial resolution by forming appropriate ink patterns at a finer spatial resolution. Ideally the structure at the finer spatial resolution is difficult or impossible for humans to perceive, and thus, the printing press creates in a printed image the illusion of dynamic range at perceptually relevant resolutions.

There are two basic classes of halftoning processes, so-called conventional and stochastic processes. We describe the invention in terms of the conventional halftoning process, which places inks of various colors on a document under the control of corresponding halftone screens. Each halftone screen typically has a distinct orientation on the document, or what is commonly referred to as a halftone “screen angle.” The screen angles are selected to avoid unpleasant visual artifacts in the image, such as Moiré patterns. Choosing the halftone properties appropriately is an important part of the art practiced by those skilled in the trade of printing, with printing establishments often achieving a characteristic “look” by judiciously choosing the properties of their halftone process.

The software and/or hardware for converting a digital continuous tone image to a halftone image is called a Raster Image Processor, or RIP. Commercial printing presses use dedicated RIPing software and/or hardware that may be included in an associated printer driver or may be integrated into the printer.

We discuss below a system than uses the halftone structure to encode data into an image in a manner that is essentially visually imperceptible. As discussed, the same image can be printed using a wide variety of halftone settings, and thus, information can be encoded into the image by controlling or strategically modifying aspects of the RIPing process in accordance with the data. In particular, we have found that information may be readily encoded via the selection of the relative order of certain or all of the color channels, the selection of associated halftone screen angles and/or the selection of associated halftone spatial frequencies, or scales. The selections of various halftone parameters are made within predetermined ranges that are designed to avoid unpleasant visual artifacts in the image, as discussed in more detail below.

The process color printing uses four dedicated halftone screens, one each for the cyan (C), magenta (M), yellow (Y) and black (K) channels. The printing process uses the screens to combine associated C, M, Y and K inks in varying intensities to create the spectrum of colors required for the image.

The halftone screen typically consists of a grid that controls how much of the associated color ink is deposited as strategically sized dots at specific locations on the image. The varying of the size and/or densities of the dots creates the illusion of variations of gray or continuous color. Although the dots may be modulated in a variety of ways, a common practice is to use a square grid for the screen and modulate the sizes of the respective dots in accordance with the color saturation for the channel. In addition, a given screen is oriented on the document relative to the other screens in order to avoid undesirable visual artifacts in the printed image.

The angles and frequencies of the C, M, Y and K halftoning screens may essentially be arbitrarily selected. However, the printing process itself may alter the selected settings based on limitations that are set by or inherent in the particular printing device. Indeed, the spatial frequencies of the various screens in the printed image may differ from the selected frequencies. As discussed in more detail below, rather than using the selected halftone settings for encoding or authentication purposes, the system may retain or utilize information relating to the altered halftone characteristics, i.e., the halftone settings as they are expected to appear based on known printer operations. Hereinafter, we refer to the printing device as a “printer,” which as discussed above produces the color images on-screen or as hard copy documents.

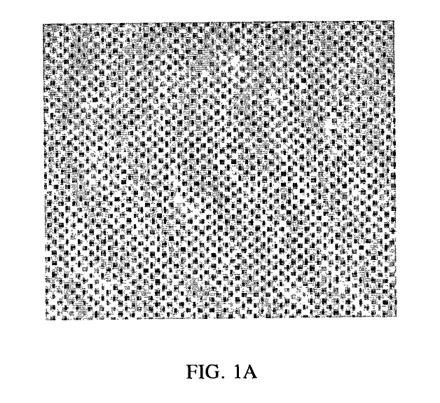

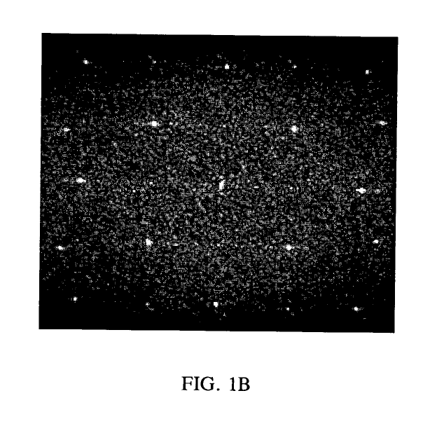

FIG. 1A depicts a printed K channel that is part of an encoded image. The pattern of ink dots in the printed K channel is based on the characteristics of the associated halftone screen (not shown), which consists of a square grid that corresponds to the underlying image and is oriented and scaled in accordance with selected halftone parameters. FIG. 1B depicts the Fourier domain energy distribution of the K channel. The transformation is also a square that consists of four points, or energy peaks, that are symmetrically arranged about the origin, or center, of the Fourier plane. The four peaks, which are the closest points to the origin, represent the fundamental spatial frequency of the halftone screen. The points farther from the origin correspond to energy peaks at the harmonic frequencies. Thus, the fundamental spatial frequency can be recovered by determining the distance of the points-of-interest from the origin. The points also depict, modulo 90°, the halftone screen angle. In FIG. 1B, the square that represents the halftone screen is oriented 45° on the document.

Ordinarily, the spatial frequencies used for the four channels are identical and the orientations of the channels are spread, to avoid beating. In practice, the three “strong” channels, namely, C, M and K, are maximally spread and the weaker Y channel is oriented between two of the strong channels. In order to encode data into the image using the halftone settings, the system strategically modifies the order, orientations and/or spatial frequencies associated with certain or all of the color channels. Accordingly, the system must take into consideration possible visible flaws in the image, and certain combinations may not be possible. Thus, the system enforces certain “quiet zones” between permissible angular orientation ranges, and sets a range defined by upper and lower boundaries for the spatial frequencies, as discussed below.

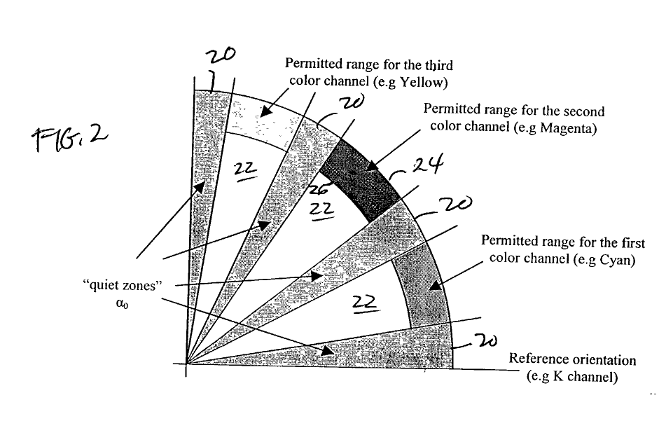

Referring now to FIG. 2, one way to enforce quiet zones 20 is to restrict the possible angular orientations of the data-encoding channels to certain ranges 22. Thus, as depicted in the drawing, the C, M and Y channels may be restricted to particular ranges relative to, for example, the K channel, which serves as the reference channel. As discussed, the visual effects of the various channels are not equal. Accordingly, the weakest of the color channels, namely, the Y channel, may be subject to less strict limitations, such as smaller quiet zones. If the spatial frequencies are also used for encoding, the spatial frequencies are restricted to the ranges between permissible upper and lower boundaries 24 and 26.

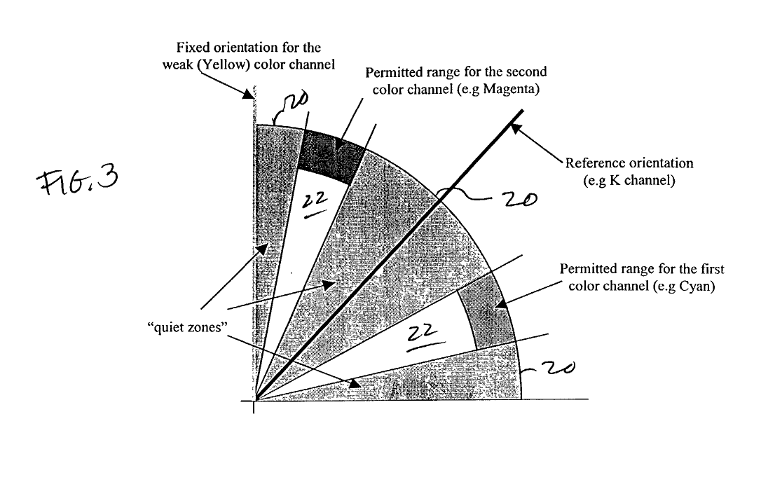

Alternatively, as depicted in FIG. 3, the orientation and spatial frequency of the Y channel may be fixed relative to the reference, or K, channel, and the remaining C and M channels may then be associated with larger permissible ranges 22 and larger associated quiet zones 20. Using the Y channel as a second reference channel may facilitate data recovery since the weaker energy levels associated with the Y channel may be harder to measure and thus characterize as halftone settings that convey encoded information.

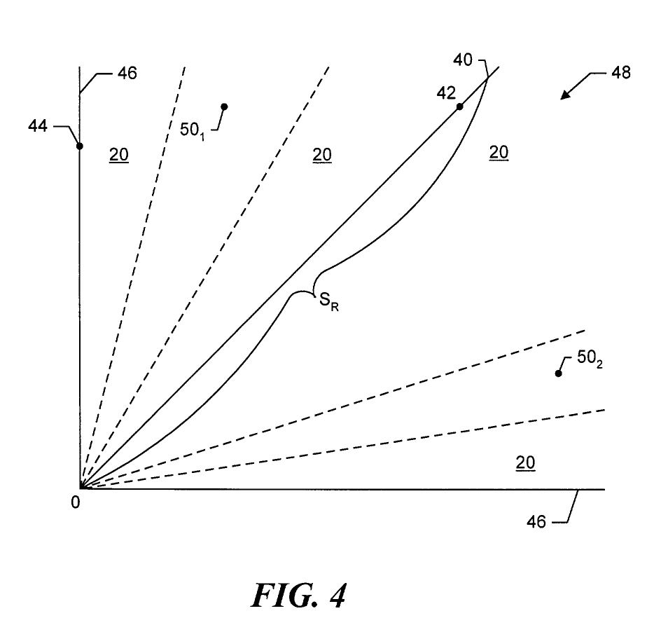

Referring now also to FIG. 4, the K channel, which is selected as a reference channel, defines an axis 40 in the Fourier plane, based on the positions of two of the associated four reference points 42 that are colinear with the origin O. Since the screen angles are modulo 90°, the axis may instead be defined by a selected reference point (as shown) and the origin. The spatial frequency of the reference channel, which defines the overall scale of the image, corresponds to the distance S_{R} of the selected reference point from the origin. If the Y channel is also associated with set halftone parameters, as in FIG. 3, the points 44 that represent the Y channel are oriented at a predetermined angle, e.g., 45, relative to the axis defined by the K channel. The Y reference points thus define a second axis 46 for the Fourier plane and the two axes, in turn, define various quadrants 48 in the plane.

The points 42 in the Fourier plane that represent the halftone settings of the K channel are referred to as “reference points,” and the points 50₁, 50₂ that represent the halftone settings that are varied in accordance with the data symbols are referred to as “data points.” The data points fall within the permissible angular and frequency ranges (FIG. 3) that are established for the data-encoding channels relative to the reference channel.

The order of the C and M channels may also be varied in accordance with the data, such that the M channel halftone information falls within the halftone screen angle range that in FIG. 3 is associated with the C channel and the C channel halftone information falls within the range that in FIG. 3 is associated with the M channel.

The data capacity of the halftone settings depends on the accuracy with which the screen angle and the associated frequency, or scale, can be estimated, and also on the limitations enforced on the halftone settings in order to avoid visual artifacts.

To decode the data from the encoded image, the system scans the image at a relatively high resolution and applies a 2-D fast Fourier transform to a region of the image that has a fairly balanced and unsaturated mix of the C, M, Y, and K channels. The transform includes energy peaks for each of the C, M, Y and K channels, and the system must first associate the various peaks in the transform with the respective channels. The system thus analyses the peaks across R, B and G channels, i.e., in the frequency domains of the respective R, B and G channels, and, for example, assigns the peaks with the highest energy levels in the R channel frequency domain to the complementary C channel. The system also assigns the peaks with the highest energy levels in the B channel frequency domain to the complementary M channel and the peaks with the highest levels in the G channel frequency domain to the complementary Y channel. The system also assigns the peaks that occur at the reference spatial frequency to the K channel. Preferably, the spatial frequency associated with the K channel is above the spatial frequencies associated with the remaining channels.

Based on the estimated C, M, Y and K energy peaks, the system determines the angles and spatial frequencies of the various data channels relative to the angle and frequency of the reference K channel. The system then recovers the data as symbols that correspond to the particular angles and/or frequencies associated with the respective data channels, and, as appropriate, also the relative order of the channels.

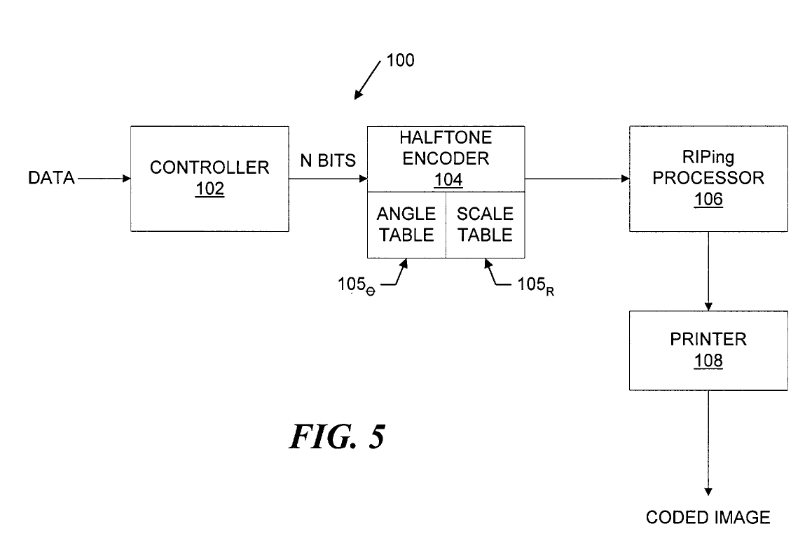

We discuss the system in terms of the encoding of the data by selectively setting both screen angles and spatial frequencies for the data-encoding channels. Referring now to FIG. 5, a halftone setting encoding system 100 includes a controller 102 that receives data that is to be encoded to produce a coded image. The controller 102 encodes the data in a conventional manner to produce one or more parity bits, or other type of redundancy bits, which are hereinafter referred to as “ECC” bits. The controller appends the ECC bits to the data and produces a payload of N bits.

A halftone setting encoder 104 parses the N bits into image symbols of b bits each. The encoder associates pairs of image symbols with selected data-carrying color channels based on the positions of the symbols in the N-bit payload. A encoder then assigns a screen angle to a given channel based on, for example, the numerical value of the first symbol in the pair associated with the channel. The halftone encodes next assigns a spatial frequency, or scale, to the given channel based on the numerical value of the second symbol in the associated pair of symbols. The halftone encoder uses tables 105 and 105_{R}, respectively, to assign the particular screen angles and frequencies.

A RIPing processor 106 sets the halftone screens for, in the example, the reference K channel and the Y channel in accordance with predetermined halftone parameters, and uses the screen angle and frequency information provided by the encoder to set the halftone screens for the data-encoding C and M channels. In the example, the spatial frequency of the K channel is set slightly above the upper boundaries associated with the data-encoding channels. A printer 108 then prints the encoded image in a conventional manner, using the reference and selected settings. As discussed, the RIPing processor may be integral with or separate from the printer 108.

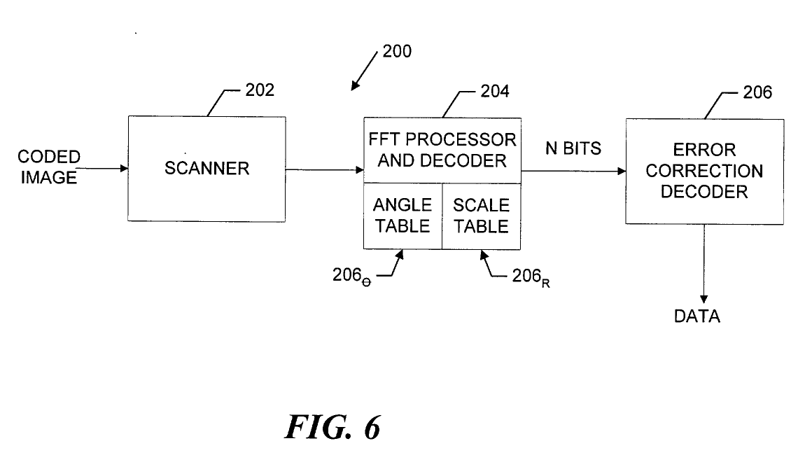

Referring now to FIG. 6, a decoding system 200 includes a scanner 202 that scans all or a portion of the encoded image at a relatively high resolution, preferably at twice the spatial frequency associated with the reference K channel. The scanner may, for example, be a hand-held scanner that is manipulated to scan a relatively small portion of the image. An FFT processor and decoder 204 performs a 2D Fourier transform on a section of the image that includes balanced and unsaturated contributions from each of the C, M, Y and K channels. The decoder 204 analyses the results in terms of R, B and G channels to associate peaks in the Fourier domain with the respective C, M, Y and K channels, as discussed above. In the example, the spatial frequencies are used for encoding the data, and thus, the decoder associates the peaks that correspond to the reference spatial frequency with the K channel.

The decoder 204 sets an axis that corresponds to the screen angle associated with K channel and determines, relative to the K channel, the screen angles and spatial frequencies associated with the respective data-encoding channels. As discussed, the data points are modulo 90°, and the decoder uses the data points 50 in a selected quadrant 148 of the Fourier plane to determine the associated screen angles and spatial frequencies (FIG. 4).

The decoder 204 uses the screen angles and spatial frequencies, respectively, to enter to look-up tables 206_{θ} and 206_{R} and reproduce the associated image symbols. The decoder then arranges the symbols in the appropriate order to reproduce the N-bit pay-load. An error correction decoder 206 decodes the string as data and ECC bits and, as appropriate, detects and/or corrects errors in the data.

The decoder 204 will likely have to interpolate the angular orientation values that are measured from the FFT. The system thus associates the measured values with the spatially closest valid spatial frequencies and screen angle values, without crossing applicable range boundaries.

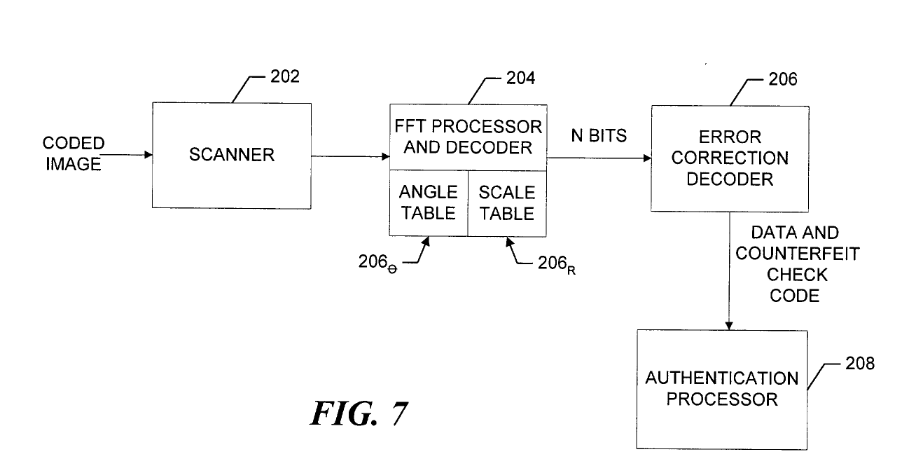

Referring now to FIG. 7, the halftone encoding may also be used to detect an unauthorized copy of an image by including in the N-bit payload a counterfeit check value. The counterfeit check value may be a fixed value or it may be a value that is derived from the data. After decoding, an authentication processor 208, as appropriate, derives a decoded check value from the recovered symbols and compares the recovered counterfeit check value with the described value. The processor determines that the image is authentic if the two values match. Alternatively, the processor determines if the recovered value matches a predetermined fixed value.

Presumably, a counterfeit copy of the image will print with halftone settings that convey random information, rather than the data and/or the counterfeit check value that are encoded into the authorized print. Accordingly, the decoding process produces random information and thus the recovered counterfeit check value has no relation to the data and/or the predetermined fixed value. The processor then labels the print as a counterfeit.

The halftone settings may be used to authenticate a printed image, whether or not data is encoded via the halftone settings. Basically, the system encodes onto an image as a digital code the selected halftone parameters, e.g., the screen angles and/or spatial frequencies, using, for example, angular symbology, a bar code or a watermark. To authenticate a printed image, the system scans the image and decodes therefrom the digital code that includes the halftone parameters. The system then measures the halftone settings from the scanned image and compares the measured settings with the decoded parameters. If the decoded and measured values agree, to within a reasonable percentage, the image is deemed an authorized print. Otherwise, the print is labeled a counterfeit.

Alternatively, the system may include the digital code as human or machine readable characters that are printed adjacent to the image. The system then decodes the halftone parameters from the printed characters and authenticates the print in the manner discussed above.

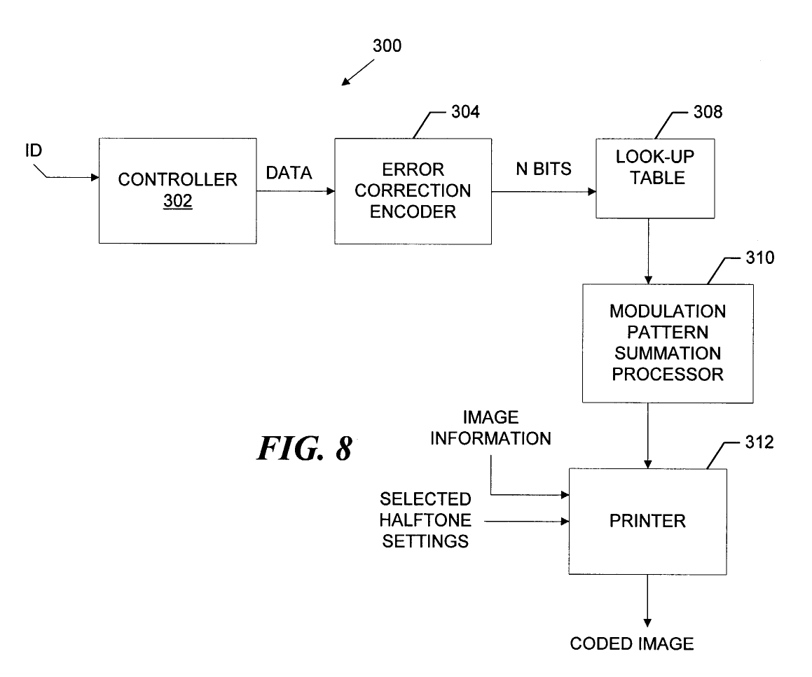

Referring now to FIG. 8, we discuss a verification system 300 by way of an example that uses the angular symbology to encode the halftone parameters onto the image in the form of a digital code. A controller 302 includes in the digital code an identifier that identifies the printer, the image and/or the owner of the image. The controller may further include in the digital code halftone parameter information that characterizes the halftone settings associated with the image. The information may be the selected halftone settings, assuming the printer does not alter the settings in the printing process. As discussed above, particular printers alter the halftone settings and/or print an image that, for example, has screen frequencies that differ from the selected settings, in accordance with printer-dependent limitations and/or printer idiosyncrasies. The information included in the code may thus be the halftone parameters as they are expected to appear in the printed image based on known printer operations.

In the example, the halftone parameter information includes a base spatial frequency that may vary in a range from 133 and 196 lines-per-inch (“lpi”), and halftone parameters that depict the screen angles (modulo 90°) and the spatial frequencies selected for the respective halftone screens. The spatial frequencies are included as positive offsets, in lpi, from the base spatial frequency.

An error correction encoder 304 encodes the data in a conventional manner and produces ECC bits that are included with the data in a payload of N bits. An angular symbology encoder 306 encodes the N bits using modulation patterns, which are sinusoids with frequencies and angular orientations selected in accordance with the data. The encoder parses the N bits into image symbols and associates the image symbols with selected modulation pattern spatial frequencies, based on the positions of the symbols in the N-bit payload. The system assigns the first d symbols to a first modulation frequency, the second d symbols to a second modulation frequency, and so forth. Next, the system assigns a modulation angular orientation to a given symbol based on the numerical value of the symbol. The encoding system enters a lookup table 308 with the symbol to assign to the symbol a modulation angular orientation. To avoid possible interference, the configuration for the angular symbology is chosen such that the N-bit payload can be encoded in the image using modulation spatial frequencies that are below the frequencies associated with the halftone screens.

A modulation pattern summation processor 310 uses a modulation angular orientation and a modulation spatial frequency assigned to a reference modulation pattern and the modulation angular orientation and modulation spatial frequency information associated with the data-carrying modulation patterns to produce a coded pattern that includes the various modulation patterns. The processor thus calculates the contributions of the reference and data modulation patterns, i.e., the various sinusoids, to the pixel intensities to produce the coded pattern. A printer 312 then combines the coded pattern with the image information and, using selected halftone settings, prints a coded image, which includes the digital code as an added texture or graininess. As discussed, the image may but need not include data that is encoded via the halftone settings.

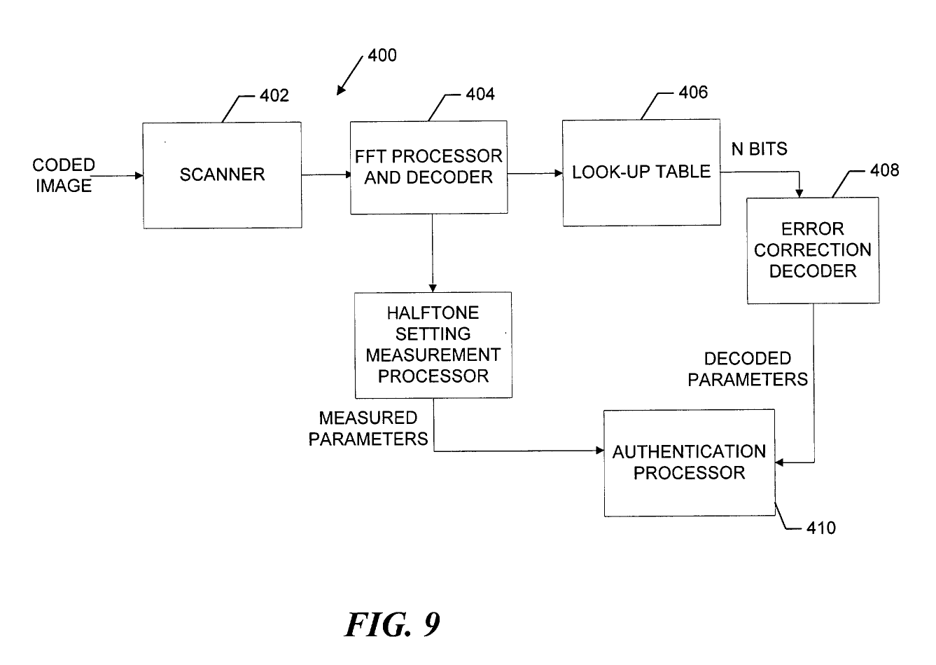

Referring now to FIG. 9, a verification decoding system 400 includes a scanner 402 that scans the coded image. An FFT processor and decoder 404 next performs a 2-D FFT and uses magnitude information to decode from the image the digital code that is encoded therein using angular symbology.

The FFT processor produces one or more pairs of data points for each sinusoid that is included in the coded pattern. The data points for a given sinusoid are located on a circle of radius Rᵢ, where Rᵢ corresponds to the associated spatial frequency. The decoder then determines the reference orientation by identifying the maximum points that lie on or sufficiently close to a circle of radius R₀, where R₀ is the spatial frequency of the reference modulation pattern. In the example, R₀ is the highest spatial frequency in the group of frequencies used to encode the data.

The decoder further determines the relative angles of the various data points and enters a look-up table 406 to reproduce the associated image symbols. Alternatively, the decoder manipulates the angular information to directly reproduce the image symbols. The decoder then arranges the symbols in an appropriate order to reproduce the N-bit payload and provides the N-bit string to an error correction decoder 408. The decoder decodes the string as data and ECC symbols and, as appropriate, detects and/or corrects errors in the data.

A halftone setting measurement processor 408 next measures the halftone settings in the image in the manner discussed above with reference to FIG. 6, using the color information that is included in the transform. The orientation of the image is determined using the reference orientation provided by the angular symbology information. Accordingly, the halftone parameters-of-interest may be the parameters associated with all of the color channels, or at least all of the stronger color channels, since a reference color channel is no longer required. In practice, the settings for the weakest channel, i.e., the Y channel, may be omitted for the purpose of authentication, since the settings are less reliably measured from the image due to the relatively low energy levels associated with the Y channel.

An authentication processor 410 determines if the measured halftone parameters correspond to the halftone parameters decoded from the image, taking into account the reference orientation and scaling information provided by the angular symbology information. If the two sets of parameters are determined to correspond, the system authenticates the print. Otherwise, the system labels the print a counterfeit.

The halftone settings used for the coded image supplied to the scanner processor 402 may be modified in accordance with data or may be selected without reference to any data. If data is encoded into the image via the halftone settings, the verification encoding system 300 provides the measured halftone settings to the halftone decoder 204 of FIG. 5, after the image is authenticated. The halftone decoder then recovers the associated data.

One of the advantages of encoding the authentication information into the image using angular symbology is that the printing establishment need not alter its halftone settings, unless data is to be encoded using the settings. Assuming no data is encoded via the halftone settings, the image is printed with the halftone settings that the printing establishment has selected to avoid unpleasant visual artifacts and to achieve a desired “look,” as discussed above.

The system can also verify the authenticity of an image print directly from the image, without requiring variable printing. The system thus need not include in or print around the image an indicia, such as bar codes, watermarks or other human or machine readable information, that specifies authentication-related information.

The counterfeit code discussed above may instead identify the owner of the image and/or the image itself. The owner and/or image identifier is associated with halftone setting information, which may, for example, be stored in a database.

The database may include one or more sets of halftone settings for a particular image, and the verification device determines if the image is authorized by determining if the measured halftone settings correspond to any one of the associated sets of settings that are retrieved from the database using the decoded identifier. The various halftone parameters associated with an image may correspond to versions of the image printed by upgraded printing systems and/or software that produces different results when an image is printed using the same halftone settings. Alternatively, the various sets of parameters may belong to various authorized printing systems.

The identifier in the image may also be used in a process of recording or logging authorized copies of the image. The verification device records, for each authorized printing or run of an image, the measured halftone settings of one or more of the printed versions of the image and an associated date and/or time, for example, the date and/or time that the versions of the image were printed. The measured halftone parameters typically vary based on the printing system used, and thus, the verification system may have recorded a number of different sets of measured parameters for various runs of a given image. Thereafter, the record or log may be used to prove that a particular copy of an image is a counterfeit, by readily establishing that the measured halftone parameters associated with the copy are not included in the record or log.

We have depicted that system as including a plurality of processors, such as the ECC encoder and the halftone setting encoder. The processors may be combined into a single processor or arranged as various other groupings of processors. The instructions for the operations that the processors perform may be stored on memory resident on the respective processors, or on memory that is resident on certain of the processors and shared with or made available to other processors. Alternatively, the instructions for one or more of the operations may be made available to or communicated to the processors by, for example, the controller. Further, the system may store, transmit, print or otherwise provide the image to a user for decoding and/or authentication. Similarly, the image may be transmitted to or provided in hardcopy to be scanned into the system for decoding and/or authentication.

The system is readily implemented by means of one or more digital processors, either general purpose or special purpose. Conventional signal processing software and algorithms are readily applied to perform the requisite processing described herein.

What is claimed is:

1. A method for use in encoding one or more symbols of data in an image that is produced in visible form using a color printing process that involves a plurality of halftone screens, the method comprising:
modifying at least one of a plurality of parameters associated with at least one of the plurality of halftone screens in accordance with the data;
setting to predetermined values the parameters associated with a halftone screen that is selected as a reference;
producing a coded image using halftone screens that incorporate the respective modified and set parameters.

2. The method of claim 1 wherein, in the step of modifying, the plurality of parameters are screen angle, spatial frequency, and associated color channel order.

3. The method of claim 2 wherein the step of modifying includes modifying the screen angle of a given halftone screen in accordance with a data symbol assigned to the corresponding color channel.

4. The method of claim 2 wherein the step of modifying includes modifying the spatial frequency of a given halftone screen in accordance with a data symbol assigned to the corresponding color channel.

5. The method of claim 4 wherein the step of modifying further includes modifying the screen angle of the given halftone screen in accordance with a second data symbol assigned to the corresponding color channel.

6. The method of claim 2 wherein the step of modifying includes selecting within two or more predetermined ranges the screen angles associated with two or more halftone screens in order to modify the relative order of the associated color channels.

7. The method of claim 6 wherein the step of modifying includes further modifying the screen angles within the predetermined ranges in accordance with the data.

8. The method of claim 7 wherein the modifying step further includes modifying the spatial frequencies of the respective halftone screens in accordance with the data.

9. The method of claim 6 wherein the modifying step further includes modifying the spatial frequencies of the respective halftone screens in accordance with the data.

10. The method of claim 5 wherein the step of modifying includes selecting the screen angles associated with two or more halftone screens to modify the relative order of the associated color channels.

11. Method for use in decoding at least one or more symbols of data encoded in an image, the method comprising:
determining reference halftone parameters associated with a reference halftone screen;
determining, relative to the reference halftone parameters, modified halftone parameters that have been modified in accordance with the data;
associating respective image symbols with the modified halftone parameters; and
arranging the image symbols to reproduce the data symbols.

12. An image in which one or more symbols are encoded, the image including:
a reference color channel in which one or more parameters of an associated halftone screen are set to reference values;
one or more data-encoding color channels in which one or more parameters of associated halftone screens are modified in accordance with the symbols, the parameters being modified relative to the parameters associated with the reference color channel.

13. The image of claim 12 wherein the one or more parameters include screen angle, spatial frequency and relative order of the color channels.

14. The method according to claim 1, wherein the one or more symbols comprise a string of bits, and the method further comprises
parsing the string of bits into image symbols,
assigning the image symbols to one or more color channels, and
the modifying step includes modifying relative to the screen angle and the spatial frequency associated with the reference halftone screen at least one of a spatial frequency and a screen angle for the halftone screen associated with the given color channel in accordance with the assigned image symbols.

15. The method according to claim 14 further including the step of assigning different spatial frequencies to the reference halftone screen and the halftone screens associated with the image symbols.

16. The method according to claim 15 wherein the reference halftone screen is assigned a higher spatial frequency than are the halftone screens associated with the image symbols.

17. The method according to claim 14 wherein the same spatial frequency and different screen angles are selected for the respective halftone screens that are associated with the image symbols.

18. The method according to claim 1, wherein the one or more data symbols include a plurality of symbols that represent a data message and error correction redundancy information.

19. An apparatus for use in encoding one or more data symbols in an image that is produced visually in accordance with a plurality of halftone screens, the apparatus including:
a halftone setting encoder that associates the one or more data symbols with respective halftone screens and modifies halftone screen angles relative to a reference screen angle in accordance with the data symbols; and
a printer that encodes the data symbols into the image by producing the image using the respective modified halftone screens.

20. The apparatus of claim 19 wherein the printer further produces the image using a reference halftone screen that is assigned the reference screen angle.

21. The apparatus of claim 19 wherein the halftone setting encoder associates further data symbols with the respective halftone screens by selecting modified spatial frequencies that have values that correspond to the further data symbols.

22. An apparatus for use in decoding one or more data symbols encoded in an image that is produced in accordance with halftone screens, the apparatus comprising:
a mechanism that determines values of parameters associated with one or more of the halftone screens, the values corresponding respectively to the one or more data symbols; and
a decoder for assigning the one or more data symbols to the parameters and arranging the symbols in the order of color channels associated with the respective halftone screens.

23. An image verification system including
A. a halftone setting encoder for assigning one or more of a plurality of halftone parameters to respective halftone screens in accordance with a string of N bits that includes data symbols and a counterfeit check code that has a predetermined relationship with the data symbols;
B. an image printer for producing an image using the assigned halftone parameters;
C. a decoder for recovering the halftone parameters from the image and associating the parameters with decoded data symbols and a decoded counterfeit check code; and
D. a processor for determining if the decoded counterfeit check code has the predetermined relationship with the decoded data.

24. The system of claim 23 wherein the processor determines if the decoded counterfeit check code has a value that is related to the values of the decoded data symbols.

25. The system of claim 24 wherein the processor determines if the decoded counterfeit check code has a predetermined value.

26. The system of claim 25 wherein the data symbols are redundancy symbols that correspond to the counterfeit check code.

27. An image verification system including:
A. an encoder that encodes onto or proximate to an image in the form of a digital code information relating to halftone parameters associated with the printing of the image;
B. a decoder for decoding the digital code from the image and determining the associated halftone parameters;
C. a halftone processor for measuring the halftone parameters used in the printing of the image; and
D. an authentication processor for determining if the image is authentic by determining if the halftone parameters associated with the code information decoded from the image and the halftone parameters measured from the image correspond to within predetermined percentages.

28. The image verification system according to claim 27 wherein the digital code comprises a plurality of data symbols, and the encoder determines respective modulation patterns to be applied to a characteristic of the image to produce respective data modulation patterns corresponding to respective data symbols, each of the respective data modulation patterns having a respective angular orientation relative to a reference modulation pattern, with the angular orientations for the data modulation patterns being selected so as to have respective values that correspond to the respective data symbols.

29. The image verification system according to claim 27, wherein the one or more symbols represent a data message and error correction information.

30. The image verification system according to claim 27 wherein the encoder encodes the digital code as a bar code.

31. The apparatus according to claim 27 wherein the encoder encodes the digital code as a digital watermark.

32. The apparatus according to claim 27 wherein the encoder encodes the digital code in the form of characters, bar codes, or spread spectrum markings that appear adjacent to the image.

33. Computer-readable memory comprising computer-executable program instructions for use in encoding one or more data symbols in an image, the instructions, when executed, causing:
determining reference halftone parameters to be applied to a reference halftone screen;
determining for each given symbol one or more modified halftone parameters that are relative to the reference halftone parameters, the modified halftone parameters being associated with one or more halftone screens;
producing the image using halftone screens that incorporate the reference and modified halftone parameters.

34. Computer-readable memory comprising computer-executable program instructions for use in decoding one or more data symbols encoded in an image, the instructions, when executed, causing:
determining from the image reference halftone parameters that are associated with a reference halftone screen;
determining from the image modified halftone parameters that are associated with halftone screens that are used for data encoding;
associating respective symbol values with the modified halftone parameters; and
arranging the symbols in accordance with the order of color channels associated with the respective halftone to reproduce the data.

35. Computer-readable memory comprising computer-executable program instructions for use in authenticating an image, the instructions, when executed, causing:
determining halftone parameters from one or more patterns imposed on an image;
measuring from the image the halftone settings used in producing the image;
determining the image to be authentic if the determined halftone parameters and the measured halftone settings correspond.

36. The memory according to claim 35, wherein the pattern imposed on the image is a bar code.

37. The memory according to claim 35, wherein the pattern imposed on the image is a digital watermark.

38. The memory according to claim 35, wherein the pattern imposed on the image is a coded modulation pattern that is a combination of data modulation patterns that correspond to a digital code that conveys the halftone parameters.

39. The memory according to claim 35 wherein the modified halftone settings are one or more of screen angle, spatial frequency and associated channel order.

40. The memory according to claim 35 wherein the pattern imposed on the image is a string of characters that appear adjacent to the image.

41. The apparatus of claim 27 wherein
the digital code is an identifier that identifies the image, the image owner or both, and
the authentication processor consults a database or table that is entered using the identifier to determine the associated halftone parameters.

42. The apparatus of claim 33 wherein
the database or table includes as the associated halftone parameters one or more sets of halftone setting information; and
the authorization processor determines if the measured parameters correspond to any one of the sets.

43. A method for authenticating an image, the method including the steps of
A. decoding from the image or a bar code or other markings adjacent to the image information that represents an identifier of one or both of the image and the image owner;
B. measuring halftone setting parameters from the image;
C. entering a database or lookup table using the decoded identifier to obtain associated halftone setting information; and
D. determining that the image is authorized if the measured halftone parameters correspond to within predetermined percentages to the halftone setting information obtained from the database or table.

44. The method of claim 43 wherein the step of determining if the image is authentic includes determining if the measured halftone parameters correspond to any one of a plurality of sets of halftone setting parameters that are included in the halftone setting information that is associated with the identifier in the database or table.

45. The method of claim 43 further including
in the step of recording, the recording of one or more sets of measured halftone parameters and identifying information for respective authorized images, and
a step of determining that an image is counterfeit if the halftone parameters measured from the image do not match any of the associated recorded sets of parameters.

46. The method of claim 45 further including, in the step of recording identifying information, recording of associated dates, times or both for the printing of respective runs of authorized images.

47. The method of claim 46 further including, in the step of recording sets of measured halftone parameters and identifying information, the recording of measured halftone parameters for one or more of the printed images in a given run.
